(19) United States
(12) Patent Application Publication
(10) Pub. No.: US 2020/0136198 A1
(43) Pub. Date: Apr. 30, 2020

(54) METHOD AND DEVICE FOR INCREASING BATTERY LIFE AND PREVENTION OF PREMATURE BATTERY FAILURE

(71) Applicant: Farida Kasumzade, Minnetonka, MN (US)

(72) Inventor: Farida Kasumzade, Minnetonka, MN (US)

(21) Appl. No.: 15/703,355

(22) Filed: Sep. 13, 2017

(51) Int. Cl. H01M 10/42; H01M 10/44

(52) U.S. Cl. CPC H01M 10/4242; H01M 2220/20; H01M 10/425; H01M 10/44

(57) ABSTRACT

This disclosure relates to ultrasonic devices and methods to use, manufacture and recondition new and degraded batteries. The disclosure may be used to manufacture or restore primary or secondary type batteries or as a preventive maintenance process for operational batteries. The disclosure utilizes an ultrasound transducer to provide ultrasound energy into a battery. It may be used to charge low or dead batteries, to clean fouled battery plates, to remix stratified electrolytic solutions and to dissolve and/or suspend solid particulates within a battery. Battery reconditioning may be accomplished through the action of the ultrasound waves directly or indirectly through the ultrasound waves producing cavitations and free radicals within the electrolyte 104. Sonication may be accomplished on a batch basis, on a controlled basis such as a timer or voltage signal, or cooperatively with the battery charging.

### BACKGROUND OF THE INVENTION

### 1. Technical Field of the Invention

This disclosure relates to ultrasonic devices and methods to increase the life, and enhance performance of new batteries as well as to rehabilitate, recharge and recondition degraded rechargeable batteries. The disclosure applies to liquid, dry, solid, metal-gas or gel battery whether a primary (non-rechargeable) or secondary (rechargeable) battery. The disclosure may be used to charge low or dead secondary batteries, improve the performance and extend the life of primary batteries, as well as to clean fouled battery plates, to remix stratified electrolytic solutions and to degrade, dissolve and/or suspend solid particulates within a battery. The present invention discloses use of the invention in initial manufacturing of primary and secondary batteries, as well as for mass production regeneration of batteries. Specifically lead acid and lithium-ion batteries are disclosed as representative embodiments of the technology.

### 2. Background

As batteries have become a staple of modern technology, battery performance and prevention of battery failure has become a very important issue to those that make and use the devices dependent on batteries. Primary (single use) batteries make up most of the battery market with chemistry ranging from zinc-carbon to lithium ion and are used in everything from flashlights and consumer electronics to implantable medical devices. They are known for being cost effective with a high power storage capacity to weight ratio. Secondary cells are rechargeable because their electrochemical reactions are electrically reversible. Rechargeable batteries come in many different shapes and sizes, ranging anything from a button cell to lead-acid or lithium ion megawatt systems designed to stabilize electrical distribution networks. Several different combinations of chemistries are available, including: lead-acid, nickel cadmium, nickel metal hydride, lithium ion, and lithium ion polymer. Having metal components, galvanic charges and often under acidic conditions make batteries susceptible to corrosion attack.

Lead acid batteries are often divided in two groups defined by application (what they are used for) and construction (how they are built). Major applications include automotive, marine, and deep-cycle. Deep-cycle applications include solar electric, backup power, as well as RV and boat batteries. The major construction types include flooded (wet), gelled, and Absorbed Glass Mat (AGM). AGM batteries are also sometimes called “starved electrolyte” or “dry”, because the fiberglass mat is only 95% saturated with sulfuric acid and there is no excess liquid in the battery case.

Lead acid batteries designed for starting automotive engines are not designed for deep discharge. They have a large number of thin plates designed for maximum surface area, and therefore maximum current output, but which can easily be damaged by deep discharge. Repeated deep discharges will result in capacity loss and ultimately in premature failure, as the electrodes disintegrate due to mechanical stresses that arise from cycling. Vehicle starting batteries kept on continuous float charge will have corrosion in the electrodes and result in premature failure. Starting batteries should be kept open circuit but charged regularly (at least once every two weeks) to prevent sulfation.

Specially designed deep-cycle cells are much less susceptible to degradation due to cycling, and are required for applications where the batteries are regularly discharged, such as photovoltaic systems, electric vehicles (forklift, golf cart, electric cars and other) and uninterruptible power supplies. These batteries have thicker plates that can deliver less peak current, but can better withstand frequent discharging.

Some batteries are designed as a compromise between starter (high-current) and deep cycle batteries. They are able to be discharged to a greater degree than automotive batteries, but less so than deep cycle batteries. They may be referred to as “Marine/Motorhome” batteries, or “leisure batteries”.

Lead acid battery life, may be prematurely shortened by electrolyte loss, separator failure, corrosion, stratification and sulfation. This disclosure describes devices and methods to prevent and/or recondition battery failure due to stratification, sulfation and corrosion.

In the charged state, each cell contains positive electrodes of elemental lead (Pb) and negative electrodes of lead(IV) oxide (PbO₂) in an electrolyte of approximately 33.5% v/v (4.2 Molar) sulfuric acid (H₂SO₄).

In the discharged state both the positive and negative become lead(II) sulfate (PbSO₄) and the electrolyte loses much of its dissolved sulfuric acid and becomes primarily water. Due to the freezing-point depression of water, as the battery discharges and the concentration of sulfuric acid decreases, the electrolyte is more likely to freeze during winter weather.

During discharge, both cathode and anode plates return to lead sulfate. The process is driven by the conduction of electrons from the negative plate back into the cell at the positive plate.

Positive Plate Reaction: Pb(s)+HSO₄⁻ (aq)→PbSO4(s)+H⁺(aq)+2e− Eq. 1

Negative Plate Reaction: PbO₂ (s)+HSO₄⁻(aq)+3 H⁺(aq)+2e−→PbSO₄ (s)+2H₂O(I) Eq. 2

Subsequent charging places the battery back in its charged state, changing the lead sulfates into lead and lead oxides. The process is driven by the forcible removal of electrons from the positive plate and the forcible introduction of them to the negative plate.

Positive Plate Reaction: PbSO₄ (s)+H⁺(aq)+2e−→Pb(s)+HSO₄⁻(aq) Eq. 3

Negative Plate Reaction: PbSO₄ (s)+2H₂O(l)→PbO₂ (s)+HSO₄⁻(aq)+3 H⁺(aq)+2e− Eq. 4

Electrolytic loss occurs nominally during use, and especially on overcharge, the water in the electrolyte splits into hydrogen and oxygen. The battery begins to gas, which results in water loss. In flooded batteries, water can be added but in sealed batteries water loss leads to an eventual dry-out and decline in capacity. Water loss from a sealed unit can eventually cause disintegration of the separator. The initial stages of dry-out can go undetected and the drop in capacity may not immediately be evident.

Separator failure occurs when two battery plates come into contact, that cell will then suffer a short and a 12 volt battery will effectively become a 10 volt battery. Plate contact can happen due to manufacturing defects, damage due to impacts, vibration, sulfation or if the separator material breaks down or plates become distorted due to excessive heat. Overcharging can also cause plate distortion and separation failure.

Corrosion failure mode is primarily due to the fact that the positive battery plates are required to perform their function as “electron collectors” in an incredibly harsh, acidic environment. What's more, batteries are frequently required to operate in high-temperature conditions, which have the effect of accelerating corrosion. To mitigate the effects of corrosion, battery manufacturers have focused their research efforts on developing corrosion-resistant lead alloys and grid manufacturing processes. Although improvements have been attained in this manner, corrosion remains one of the most common failure modes of lead acid batteries.

Sulfation of lead-acid batteries results in the loss of the ability to accept a charge when discharged for too long due to the crystallization of lead sulfate. Batteries generate electricity through a double sulfate chemical reaction. Lead and Lead(IV) Oxide, which are the active materials on the battery's plates, react with sulfuric acid in the electrolyte to form lead sulfate. The lead sulfate first forms in a finely divided, amorphous state, and easily reverts to lead, lead oxide and sulfuric acid when the battery recharges. As batteries cycle through numerous discharge and charges, the lead sulfate slowly converts to a stable crystalline form that no longer dissolves on recharging. Thus, not all the lead is returned to the battery plates, and the amount of usable active material necessary for electricity generation declines over time.

Since batteries have a low level loss even when in storage, sulfation failures may occur even if the battery is not in use. As such sulfation may result from a lead acid battery being kept in a discharged state for a period of time. In this situation, the lead sulfate formed in the normal chemical discharge reaction re-crystallizes and hardens. This non-conductive lead sulfate blocks the conductive path required for recharging. Once they're in this crystalline state, the sulfate crystals are very difficult to convert back to the charged lead and lead oxide required to produce the battery's energy-producing chemical reaction. Even a well-maintained battery will, over time, lose some of its capacity due to the continued growth of large sulfate crystals that are not entirely reabsorbed during the charging cycle. The sulfate crystals are also larger in volume than the original paste, so they can actually mechanically deform the plate or grid by pushing the plate material apart. Sulfation is a common problem in recreational vehicle applications where extended off-season storage leads to dead batteries that will not accept a recharge.

Cycle life is a term that refers to the number of deep discharges that a battery can endure without significantly diminishing its useful life. As users have become more familiar with rechargeable batteries in cell phones and laptop computers, they have become comfortable with bringing these batteries down to an almost totally discharged state and bringing them back to full capacity with a recharge of just a few hours. In contrast, conventional lead acid batteries, because of inherent design and utilization limitations, are only capable of handling discharges down to 20 to 30 percent of full capacity. The number and frequency of these deep discharges can lead to a drastic reduction in the battery's overall life span. A motorist who forgets to turn his or her headlights off and has to have the battery recharged because it's totally dead most never realizes that the battery has suffered a deep-discharge “injury” that will significantly shorten its useful life span.

Sulfation occurs in all lead-acid batteries during normal operation. Eventually it clogs the grids, impedes recharging and ultimately expands, cracking the plates and destroying the battery. In addition, the sulfate portion (of the lead sulfate) is not returned to the electrolyte as sulfuric acid. The large crystals physically block the electrolyte from entering the pores of the plates.

Sulfation also affects the charging cycle, resulting in longer charging times, less efficient and incomplete charging, and higher battery temperatures.

As a lead acid battery discharges, lead sulfate crystals are deposited on the plates as part of the normal chemical reaction that results in the flow of electrons (at the same time, the sulfuric acid electrolyte is being converted to water). During charging, the chemical reaction is reversed and the lead sulfate crystals are converted back to lead on the negative electrode and lead oxide on the positive electrode.

If however, the battery is left for extended periods not fully charged, or is in use but not reaching a fully charged state, the lead sulfate crystals will harden and will not convert back to lead or lead oxide during charging. This effect will occur more quickly at higher temperatures. Once this happens, the capacity of the battery will be reduced.

During use, small sulfate crystals form, but these are normal and are not harmful. During prolonged charge deprivation, however, the amorphous lead sulfate converts to a stable crystalline that deposit on the negative plates. This leads to the development of large crystals, which reduce the battery's active material that is responsible for high capacity and low resistance Sulfation also lowers charge acceptance; with sulfation charging will take longer.

Sulfation occurs when a lead acid battery is deprived of a full charge resulting in premature battery failure. For example in the automotive industry, the battery is the number one cause of automotive failure. These incidents can result in negative perceptions as to the overall vehicle. This is common with starter batteries in cars that are driven in the city with load-hungry accessories engaged. A motor in idle or at low speed cannot charge the battery sufficiently. As such, even new vehicles used in urbanized areas often have extremely short battery lives.

Electric wheelchairs have a similar problem in that the users might not charge the battery long enough. Lead acid must periodically be charged 14-16 hours to attain full saturation. An eight-hour charge during the night when the chair is free is often not enough to avoid causing premature failure.

Solar cells and wind turbines do not always provide sufficient charge, and lead acid banks may then succumb to sulfation. This happens in remote parts of the world where villagers draw generous amounts of electricity with insufficient renewable resources to charge the batteries. The result is a short battery life. Only a periodic fully saturated charge could solve the problem, but without an electrical grid at their disposal, often this is almost impossible.

Permanent sulfation sets in when the battery has been in a low state-of-charge for weeks or months, and at this stage no form of restoration has formerly been possible.

Stratification can develop if a battery is not being fully charged (when a battery is fully charged some gassing will cause a mixing of the electrolyte) and if the battery is static (no movement to help mixing). A typical lead-acid battery contains a mixture with varying concentrations of water and acid. This occurs because there is a slight difference in density between water and acid, and if the battery is allowed to sit idle for long periods of time, the mixture can separate into distinct layers with the water rising to the top and the acid sinking to the bottom. This results in a difference of acid concentration across the surface of the plates, and can lead to greater corrosion of the bottom half of the plates.

The electrolyte of a stratified battery concentrates on the bottom, starving the upper half of the cell. Acid stratification occurs if the battery dwells at low charge (below 80 percent), never receives a full charge and has shallow discharges. In addition to promoting sulfation, driving a car for short distances with power-robbing accessories contributes to acid stratification because the alternator cannot always apply a saturated charge under such conditions. Additionally, the upper portions of the electrolyte, not having low solute levels has a minimal freezing point depression from pure water and the making portions of the battery is very susceptible to freezing in cold climates. So, as described, acid stratification is not a battery defect per se but the result of a particular usage.

Battery failure is a potential cause of battery powered implantable medical devices such as implantable cardioverter-defibrillators (ICDs), nerve stimulators and implantable pumps. Unanticipated battery depletion with an ICD can have life-threatening consequences. These devices use primary batteries often lithium ion type. Premature battery failure in practice has been attributed to the presence of lithium clusters near the cathode, causing a short circuit and high current drain. One aspect of this disclosure relates to ultrasonic devices and methods to increase the life of batteries and to recondition by disrupting these lithium clusters, thus reconditioning the degraded battery. The disclosure utilizes a focused ultrasound transducer to direct ultrasound energy through a patient's skin into a battery within an implanted medical device without removing the medical device from the patient.

Ultrasound energy may be used to charge low or dead batteries, to clean fouled battery plates, to remix stratified electrolytic solutions and to dissolve and/or suspend solid particulates within a battery. As ultrasound waves may be transmitted through gas, liquid or solid phases, ultrasound based processes are suitable for liquid, dry or mixed phase (gas and solid) battery designs. Battery reconditioning may be accomplished through the action of the ultrasound waves directly or indirectly through the ultrasound waves producing cavitations and free radicals within the battery solution if preferred. Alternatively, when preferred, ultrasound may be applied at lower energy levels that do not produce cavitation. Sonication may be accomplished on a batch basis, on a controlled basis such as a timer or voltage signal, or cooperatively with the battery charging cycle.

### SUMMARY OF THE INVENTION

This disclosure is directed to the devices and methods to initialize batteries, recharge batteries and recondition and rejuvenate used batteries using ultrasonic energy.

Application of ultrasound energy can be used to create free radicals and ions to recharge batteries in cooperation with or in place of conventional generators and battery chargers. The energy state provided by free radicals can drive the electrochemistry of the battery cell toward the charge state in cooperation with or in place of the energy conventionally used to charge a battery with a generator or battery charger.

The application of ultrasound energy can be used to rejuvenate, recondition or improve battery efficiencies for batteries operating at less than full capacity. The ultrasound energy may even be used to rejuvenate batteries that are not usable for a specific application, to be reused for the same or alternate applications. For example, an electric car battery operating at 40% maximum capacity may be unsuitable for this use. Improving the maximum capacity using ultrasound energy may recondition the battery for use in electric car or other uses such as backup power storage.

Ultrasound energy can be utilized to remove corrosion and rehabilitate batteries that have become impaired through sulfation. The intensive energy release through ultrasound waves and cavitation can erode insoluble lead sulfate deposits from contaminated plates, degrade and re-dissolve insoluble materials into the acid solution. As such, the impaired capacity of the overall battery can be restored.

As ultrasound energy may be transmitted through liquids and solids, devices for the application of ultrasound energy can be handled probe devices that are designed to transmit ultrasound through the battery case which may be a metal, but is typically rubber or plastic, ceramic or fiberglass material. The ultrasound energy may also be directly added to the battery by being immersed into the cell through an orifice such as a fill cap or specially included port. In addition, to rapidly condition a large number of batteries an assembly line approach may be used for either internal immersion or external transmission of the ultrasound energy.

In order to maximize the efficiency of the ultrasound transmission, it is preferable to avoid an air gap between the solid or liquid materials of the battery. This is use of ultrasound conductive gel is commonly used in ultrasound imaging by using an ultrasound conductive gel between the transducer and the battery. This would likely be standard procedure when applying ultrasound energy to an implanted medical device.

The ultrasound device may be installed in a configuration wherein the ultrasound is provided as an independent treatment by the device operator as a maintenance or repair program. Alternatively, an ultrasound device could be installed in cooperation with the battery as an integral or attached device. The operation of the device could operate continuously, be activated manually, or in response to some signal such as battery performance, timer or other automatic signal.

In one aspect, the present invention using ultrasound energy provides a new method to extend life and prevent premature failure of any battery.

In one aspect, the present invention using ultrasound energy to improve battery insurance using a Langevin or a flat piezoelectric crystal transducer

In another aspect, the present invention provides a new primary and secondary battery, that is amenable to mass production processes.

In yet another aspect, the present invention uses ultrasound energy to provide a primary and secondary battery with improved functionality during the battery lifecycle.

In yet another aspect, the present invention may be used on solid, liquid, gas or multi-phase battery designs.

In yet another aspect, the present invention may be used to mix an electrolyte within a battery to remove density stratification within the electrolyte.

In yet another aspect, the present invention may be used to reduce the particle size and/or solubilize particulates.

In yet another aspect, the present invention may be used to reduce sulfation deposit within a lead-acid battery.

In yet another aspect, the present invention may be used with an ultrasound conductive gel to improve physical contact and ultrasound transmission to a battery.

In yet another aspect, the present invention may be used for applying ultrasound energy externally through a patient's skin to the battery of an internal medical device.

### BRIEF DESCRIPTIONS OF THE DRAWINGS

The present invention will be shown and described with reference to the drawings of preferred embodiments and clearly understood in detail.

FIG. 1 depicts a three dimensional cut away view of a secondary type lead/acid wet cell battery.

FIG. 2(a) depicts an internal side view of a non-stratified wet cell battery.

FIG. 2(b) depicts an internal side view of a stratified wet cell battery.

FIG. 3 depicts a schematic view of Lithium crystal formation.

FIG. 4(a) depicts a schematic representation of active or reversible crystal formation in a secondary type battery.

FIG. 4(b) depicts a schematic representation of insoluble or inert crystal formation in a secondary type battery.

FIG. 5 depicts a photomicrograph of lead sulfate in a crystalline and an amorphous state.

FIG. 6(a) depicts a side view of a battery cell being treated with a Langevin transducer.

FIG. 6(b) depicts a side view of a battery being treated with multicell battery being treated with two Langevin transducers.

FIG. 7(a) depicts the use of an immersable ultrasound transducer directed to sonicate various regions of the battery.

FIG. 7(b) depicts the use of a transducer externally or internally attached to the battery container wall or base.

FIG. 8(a) depicts a flat shaped ultrasound transducer.

FIG. 8(b) depicts a cymbal shaped ultrasound transducer.

FIG. 8(c) depicts a two sided cymbal shaped ultrasound transducer.

FIG. 8(d) depicts an angled shaped ultrasound transducer.

FIG. 8(c) depicts a ball shaped ultrasound transducer.

FIG. 9(a) is a side view of ultrasonic battery on a moving platform treated with a Langevin transducer during the manufacturing process.

FIG. 9(b) is a side view of ultrasonic battery on a moving platform treated with flat or Cymbal transducers during the manufacturing process.

FIG. 10(a) shows a representative view of a sonicator with a conical ultrasound tip.

FIG. 10(b) shows a representative view of a sonicator with a ball shaped ultrasound tip.

FIG. 10(c) shows a representative view of a sonicator with a flat ultrasound tip.

FIG. 10(d) shows a representative view of a sonicator with a cymbal shaped ultrasound tip.

FIG. 10(e) shows a representative view of a sonicator with a spherical shaped ultrasound tip.

FIG. 10(f) shows a representative view of a sonicator with an angled flat ultrasound tip.

FIG. 11 is a perspective view showing a sonication process of for various types of batteries on a moving ultrasound platform the platform integrated with a sonication or ultrasound source during or following the manufacturing process.

FIG. 12(a) depicts a side view of a battery assembled to include a permanent integral Langevin transducer.

FIG. 12(b) depicts a side view of a battery assembled to include two permanent integral Langevin transducers.

FIG. 12(c) a side view of a battery assembled to include multiple permanent integral ultrasound transducers directed to sonicate various regions of the battery.

FIG. 12(d) depicts a side view of a battery assembled to include two permanent integral internally attached immersable ultrasound transducer within the battery container wall or base.

FIG. 13(a) depicts a side view in which the sonicated electrolyte is added to the battery case after passing through a Langevin transducer.

FIG. 13(b) depicts a side view in which the sonicated electrolyte is added to the battery case after passing through a flat piezoelectric crystal transducer.

FIG. 14 depicts a three dimensional view of an ultrasound probe applying ultrasound energy into a battery cell through the battery casing using an ultrasound conductive gel.

FIG. 15 depicts a three dimensional view of an ultrasound probe inserted into a battery cell

FIG. 16 depicts three dimensional of ultrasound probes inserted into a battery using an automated assembly line.

### DETAILED DESCRIPTION OF THE INVENTION

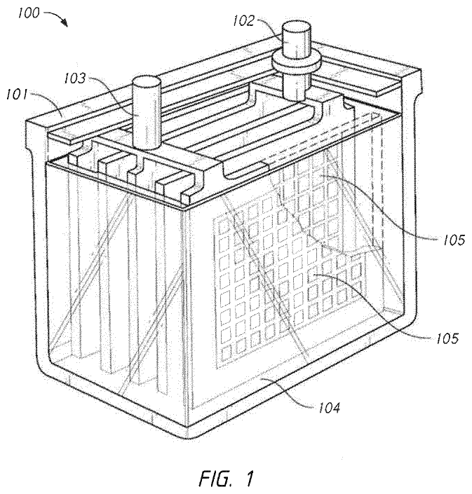

A conventional lead-acid battery is shown in FIG. 1. This is a secondary type wet cell rechargeable battery. The battery 100 contains electrolyte 104 within a battery case 101. Also within the battery case 101 are plates 105, which may be alternating anodes and cathodes separated by spacers to prevent short circuiting. The anodic plates are electrically connected to the anode terminal 103 of the battery, with the cathodic plates connected to the cathode terminal 102. The terminals protrude through the battery case 101 to allow connecting the battery for use.

The electrolyte 104 provides the electrically conducting solution between the anode terminal 103 and the cathode terminal 102. Electrolyte 104 is often water with a soluble salt, acid or base. Electrolyte 104 may also be in liquid, gelled, polymers and dry materials.

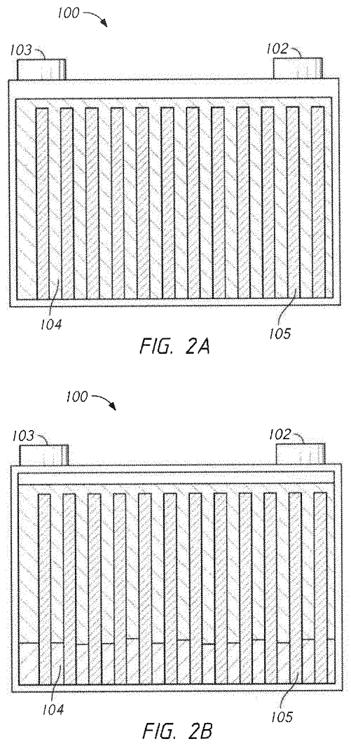

A representative view of a homogenous electrolyte 104 is provided in FIG. 2(a). The electrolyte 104 does not have vertical density gradients between the plates 105. FIG. 2(b) depicts an internal side view of a stratified wet cell battery having high density electrolyte 104 at the bottom of the battery case 101. Stratification can lead to battery failure itself. It also provides an environment promoting sulfation which can then result in battery failure.

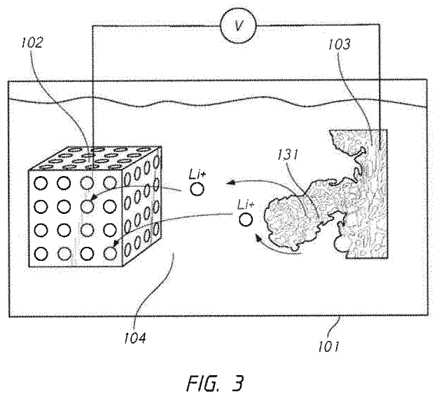

Dry cells are also subject to crystal formation. As a representative embodiment, FIG. 3 depicts a schematic view of lithium crystal formation in a lithium ion battery. Under low voltage or high voltage conditions, the formation of an inert or insoluble 131 is formed. This insoluble precipitate 131 will reduce the capacity of the battery 100 and may lead to short-circuiting and battery failure.

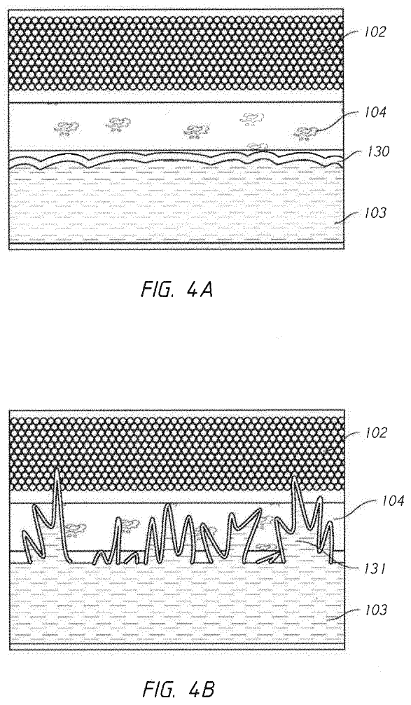

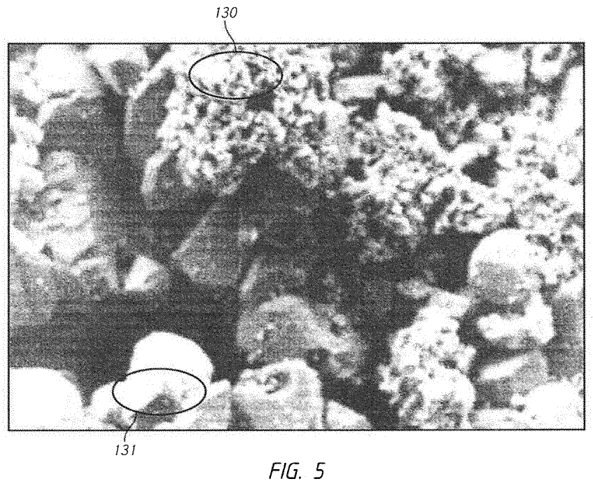

In a secondary type lead-acid battery, FIG. 4(a) depicts a schematic representation of soluble or active precipitate 130 formation. With the PbSO₄ being in the soluble form, it has a homogenous structure being reversible as the battery 100 is charged. FIG. 4(b) depicts a schematic representation of insoluble or inert precipitate 131 having a crystalline formation which is not reversible upon recharging the battery. As this form of precipitate accumulates, the battery 100 performance deteriorates and eventually fails. FIG. 5 shows a visual representation of the two forms of precipitate. As described previously, the lead sulfate generated in the discharge of a battery will be in the form of amorphous lead sulfate or crystalline lead sulfate. Although both forms are produced, it is only the amorphous lead sulfate that is resolubilized during normal use as the battery is charging. As the inert crystalline lead sulfate builds up on the battery plates, the battery gradually loses its capacity to hold a charge. With the application of ultrasound energy, crystalline lead sulfate can be disrupted to dislodge from the battery plates to allow additional surface area to be used. Furthermore, the ultrasound energy can be further utilized to solubilize the lead sulfate so the lead can be reincorporated into the battery charge cycle. Additionally, using the present disclosure, ultrasound energy can be preemptively applied to a battery, to roll back the accumulation of crystalline lead sulfate and thereby extend the useful life of the battery. Of course such preemptive use of ultrasound energy would also prevent the related issue of acid stratification that if uncorrected would also result in battery failure.

Emitting ultrasonic waves into a battery solution induces cavitations, small bubbles, within the battery solution and causes solids and/or precipitates within the battery solution to vibrate. As the ultrasound waves pass through the battery solution, cavitations are spontaneously formed within the battery solution. Explosion of the cavitations creates tiny areas of high pressure within the battery solution. Releasing high pressure into the battery solution, the explosions of the cavitations provide the energy needed to treat the battery solution and objects or precipitates within the battery solution. In addition to creating cavitations, ultrasound waves emitted into a battery solution vibrate precipitates and/or objects within the battery solution. As precipitates and/or objects within the battery solution vibrate, bonds holding the precipitates together and/or bonds holding precipitates to an object weaken and sheer. The cavitating battery solution can also induce the formation of high energy free radical compounds which may react with materials of the battery to drive the chemistry of the battery toward a charged state.

In cavitation, micron-size bubbles form and grow due to alternating positive and negative pressure waves in a solution. The bubbles subjected to these alternating pressure waves continue to grow until they reach resonant size. Just prior to the bubble implosion, there is a tremendous amount of energy stored inside the bubble itself.

Temperature inside a cavitating bubble can be extremely high, with pressures up to 500 atm. The implosion event, when it occurs near a hard surface, changes the bubble into a jet about one-tenth the bubble size, which travels at speeds up to 400 km/hr toward the hard surface. With the combination of pressure, temperature, and velocity, the jet frees contaminants from their bonds with the substrate. Because of the inherently small size of the jet and the relatively large energy, ultrasonic energy has the ability to reach into small spaces and remove entrapped materials very effectively.

The conditions under which microbubbles become unstable leading to transient cavitation in which a bubble violently collapses during a single acoustic half-cycle producing high temperatures and pressures is not well known. It is known that in aqueous solutions transient cavitation initially generates hydrogen atoms and hydroxyl radicals which may recombine to form hydrogen and hydrogen peroxide or may react with solutes in the gas phase, at the gas-liquid boundary or in the bulk of the solution.

In order to produce the positive and negative pressure waves in the aqueous medium, a mechanical vibrating device is required. Ultrasonic manufacturers make use of a diaphragm or horn attached to high-frequency transducers. The transducers, which vibrate at their resonant frequency due to a high-frequency electronic generator source, induce amplified vibration of the diaphragm or horn. This amplified vibration is the source of positive and negative pressure waves that propagate through the solution in the battery case 101. When transmitted through a battery solution, these pressure waves create the cavitation processes. The resonant frequency of the transducer determines the size and magnitude of the resonant bubbles.

The basic components of an ultrasonic system include one or more ultrasonic transducers, an ultrasound generator and the battery to be treated. A key component is the transducer that generates the high-frequency mechanical energy. There are two types of ultrasonic transducers used in the industry, piezoelectric and magnetostrictive. Both have the same functional objective, but the two types have different performance characteristics.

Piezoelectric transducers are made up of several components. The ceramic (usually lead zirconate) crystal may be sandwiched between two strips of tin. When voltage is applied across the strips it creates a displacement in the crystal, known as the piezoelectric effect. When these transducers are mounted to a diaphragm (wall or bottom of the battery), the displacement in the crystal causes a movement of the diaphragm, which in turn causes a pressure wave to be transmitted through the aqueous solution in the battery case 101. Piezoelectric transducers are often mounted to the battery case 101 with an epoxy adhesive. The assembly is inexpensive to manufacture due to low material and labor costs. This low cost makes piezoelectric technology desirable for applications having a ultrasound transducer permanently mounted to the battery.

Magnetostrictive transducers may also be used for ultrasonic battery conditioning. Magnetostrictive transducers consist of nickel laminations attached tightly together with an electrical coil placed over the nickel stack. When current flows through the coil it creates a magnetic field. This is analogous to deformation of a piezoelectric crystal when it is subjected to voltage. When an alternating current is sent through the magnetostrictive coil, the stack vibrates at the frequency of the current producing the ultrasound energy.

Battery cases for lead-acid batteries in particular are generally rectangular and can be manufactured in just about any size. Transducers may be located at any surface of the case but are usually placed in the bottom or on the sides. They may be placed on multiple surfaces when a higher watt density is desired. Alternatively, the transducers can be incorporated into the case wall. Furthermore, a watertight immersible transducer unit may be located within the battery itself. In some instances the immersible transducer units may be temporarily inserted into the electrolyte 104 through an access port or fill cap through the top of the case to expose the electrolyte 104 and internal plates to a temporary application of ultrasound energy.

Subjecting a electrolyte 104 to ultrasonic waves enables various treatments of the electrolyte 104 and battery plates or precipitates within the solution. Furthermore, large particles of PbSO₄ coating the battery plates can be dislodged when subjected to ultrasonic waves and eventually broken down into smaller particles and ultimately into colloidal and dissolved solids. Ultrasonic waves traveling within a battery solution may also be utilized to mix the stratified layers of battery solution. Furthermore, to the extent the ultrasound energy can be use to solubilize the PbSO₄ which then may form reaction products of PbO₂ (s) and Pb(s) the ultrasound energy is useful for recharging the battery as an alternative to the charger typically used.

Trapping energy within cavitations, releasing energy from the explosions of cavitations, and/or inducing vibration of precipitates, ultrasonic waves emitted into a electrolyte 104 sheer the bonds holding precipitates together such as, but not limited to, adhesive bonds, mechanical bonds, ionic bonds, covalent bonds, and/or van der Waals bonds, thereby separating the precipitates. Ultrasonic waves passing through the electrolyte 104 induce vibrations in precipitates within the electrolyte 104. As the precipitate vibrates, the bonds holding the precipitates together begin to stretch, weaken, and eventually break these bonds. Furthermore, precipitates within and/or near an exploding cavitation is exposed to tremendous changes in pressure that weakens, if not breaks, the bonds. Eventually the bonds holding the precipitate together become so weakened and strained that they break releasing small pieces and/or molecules of the precipitates into the electrolyte 104. To the extent these compounds in the electrolyte 104 are at a higher energy state, they may directly or indirectly through reaction with other compounds assist in charging the battery.

Any given ultrasound transducer 110 within the battery case 101 may emit ultrasonic waves of a particular frequency and/or amplitude or may emit ultrasonic waves into the battery varying in frequency and/or amplitude. The frequency of the ultrasonic waves emitted by a ultrasound transducer 110 should be at least approximately 18 kHz. A frequency of about 26 kHz may be useful for destratifying and mixing the electrolyte 104. Preferably a ultrasound transducer 110 emits ultrasonic waves into the battery case 101 with a approximately 1 MHz and approximately 5 MHz. In a further embodiment, the frequency may be between approximately 20 kHz and approximately 50 kHz. It may be preferable to apply a short intense application of ultrasound energy to quickly disrupt corroded or fouled plates. Alternatively, it may be preferable to continually provide a relatively low intensity ultrasound to prevent sulfation and continually clean and/or charge the battery. As such ultrasound intensity may vary from 1 to 10,000 watt per second per square centimeter. The corresponding time periods may vary from 0.1 seconds at the high dose, to several hours at the low dose. The amplitude of the ultrasonic waves emitted into the electrolyte 104 by a ultrasound transducer 110 is preferably at least approximately 1 micron or greater.

The ultrasound transducer 110 may be activated simultaneously. Alternatively, the ultrasound transducers 110 may be activated sequentially such that an ultrasound transducer 110 is activated when the preceding transducer with respect to the flow of electrolyte 104 through the battery case 101, is deactivated. The charged condition of the battery can be monitored by any of several methods such as the specific gravity of the electrolyte 104, the batteries voltage output or measuring the capacitance of the battery.

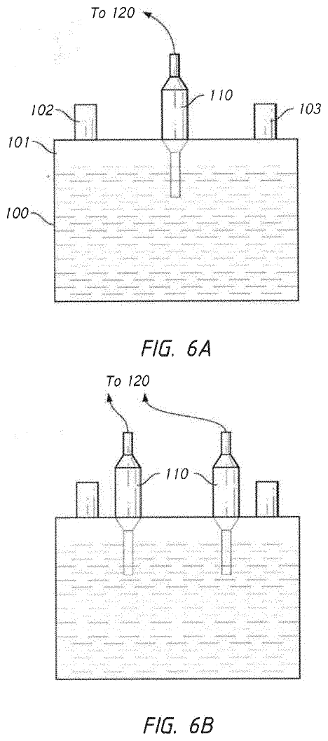

With reference to FIG. 6(a) a conventional lead acid battery 100 is shown with an ultrasound generator 120 driving an ultrasound transducer 110 in the shape of a horn. The ultrasound generator 120 controls the duty cycle of the sonication. The duty cycle may for example, be continuous, pulsed or modulated. In this embodiment, the distal tip of the ultrasound transducer 110 contains a radiating surface. The radiating surface is submerged in the electrolyte and 104 energized for a period of time. The ultrasound horn is then moved the next cell and the process is repeated until all cells have been treated. Since ultrasound waves are transmitted through the walls separating the cells, it may be possible to treat multiple cells with a each insertion of the ultrasound horn. This method is particularly adaptable for use at an auto repair garage. The equipment could be somewhat portable and would be useful for road side service of vehicles needing battery reconditioning.

Typically a 12 volt automotive battery will have six individual cells connected electrically in series. In FIG. 6(b) two cells of the multicell battery are being treated simultaneously with two Langevin transducers.

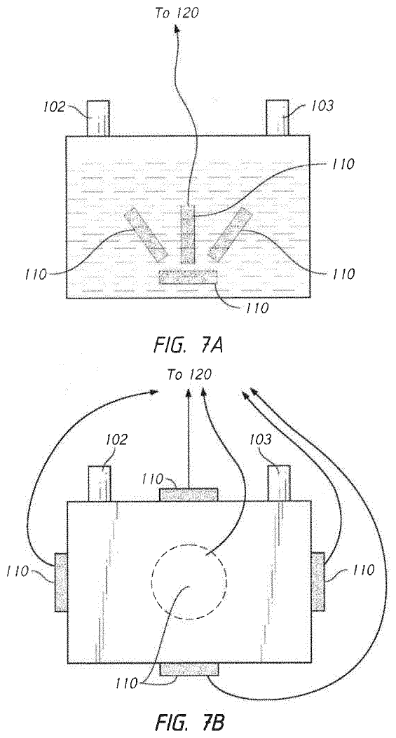

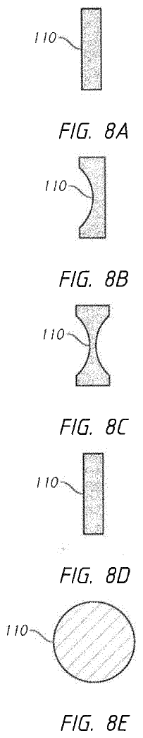

FIG. 7(a) depicts the use of an immersable piezoelectric ultrasound transducer 110 placed internally in the case and directed to sonicate various regions of the battery. FIG. 7(b) depicts the use of a transducer externally attached to the battery container wall or base. This installation can be at any side as well as the top and bottom of the battery case 101. The transducers may be either permanently or temporarily mounted to or within the battery case 101. Examples of various shapes of piezoelectric transducers are provide in FIGS. 8(a-e) and include: flat, cymbal, double cymbal, angled and ball shaped, with the shape used dependent on the shape of the case, battery chemistry, specific history and use of the battery. The ultrasound transducers 110 may be driven by a variety of wave patterns such as, but not limited to, square, triangle, trapezoidal, sinusoidal, and/or any combination thereof.

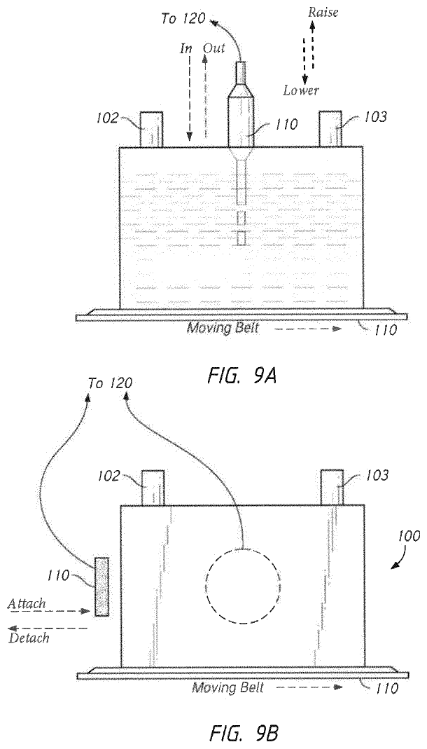

FIG. 9(a) is a side view of ultrasonic battery 100 on a moving platform treated with a Langevin transducer during the manufacturing process. In this embodiment disclosure a plurality of ultrasound transmitters 110 are held in place against the battery case 101. The transducers may be located at any desired position on the battery case 101. In this configuration the ultrasound transmitters 110 could be activated by a timer at desired intervals such as a signal based on battery charge rate or battery voltage. In addition, the ultrasound transmitters 110 could be operated continually whenever the battery is being charged to prevent sulfation from occurring.

FIG. 9(b) is a side view of ultrasonic battery on a moving platform treated with flat or Cymbal transducers during the manufacturing process. An array of ultrasound transmitters 110 are placed beneath the bottom of the battery. In this configuration, a relatively inexpensive design may be chosen, with a permanent installation with the battery. As the ultrasound is being applied vertically through the electrolyte 104, this design would be particularly efficient at mixing horizontal density stratifications within a battery.

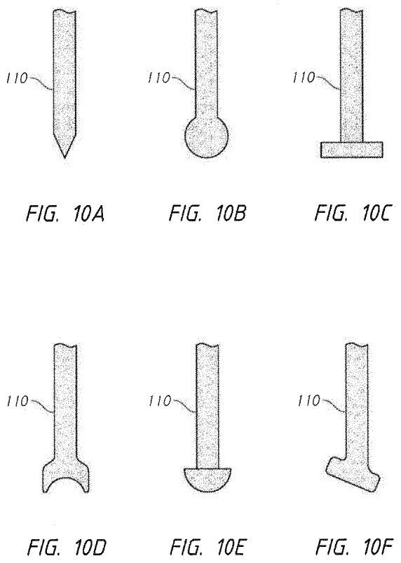

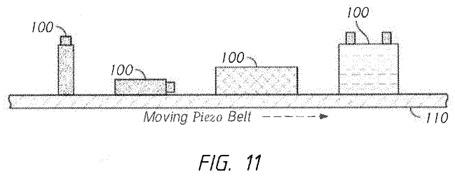

FIG. 10(a-f) show representative views of several sonicator ultrasound tips. These include conical, ball shaped, flat, cymbal, spherical and angled flat FIG. 11 is a perspective view showing a sonication process for various types of batteries on a moving ultrasound platform the platform integrated with a sonication or ultrasound source during or following the manufacturing process.

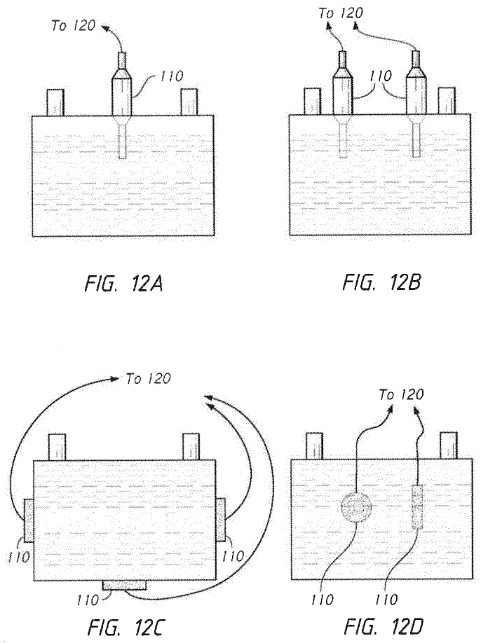

FIGS. 12(a-b) show a variety of manufactured batteries that include the ultrasound transducer as part of a battery maintenance system. In this configuration, the ultrasound treatments can be an integral part of the uses device, with automatic controls based on based on user preferences or manufacturers recommendations left to the discretion of the owner. FIG. 12(a) depicts a side view of a battery assembled to include a permanent integral Langevin transducer. FIG. 12(b) depicts a side view of a battery assembled to include two permanent integral Langevin transducers. FIG. 12(c) a side view of a battery assembled to include multiple permanent integral ultrasound transducers directed to sonicate various regions of the battery. FIG. 12(d) depicts a side view of a battery assembled to include two permanent integral internally attached immersable ultrasound transducer within the battery container wall or base.

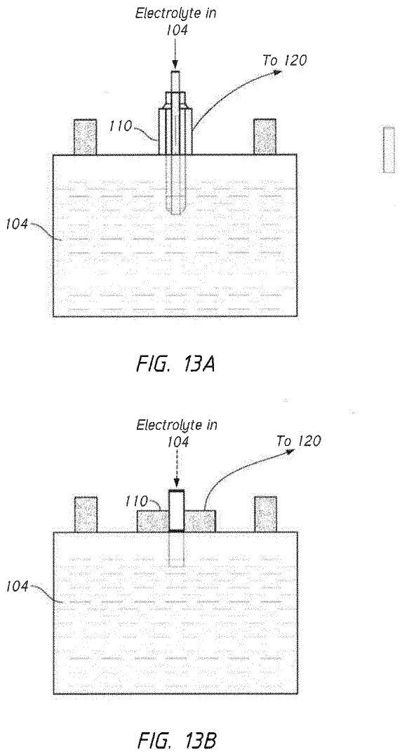

FIG. 13(a) depicts a side view in which the sonicated electrolyte is added to the battery case 101 after passing through a Langevin transducer. Wet cell batteries are sometimes shipped without acid to save shipping costs. As such, the acid must be added and the battery charged over an extended period of time to initialize the battery for use by creating the appropriate chemical species within the battery. The application of ultrasound energy can intensively agitate the acid to quickly solubilize the particulate materials by dissolving the solid compounds thus quickly charging the battery so that it is available for use. As ultrasound may be transmitted through solids as well as liquids, FIG. 13(b) depicts a side view in which the sonicated electrolyte is added to the battery case 101 after passing through a flat piezoelectric crystal transducer.

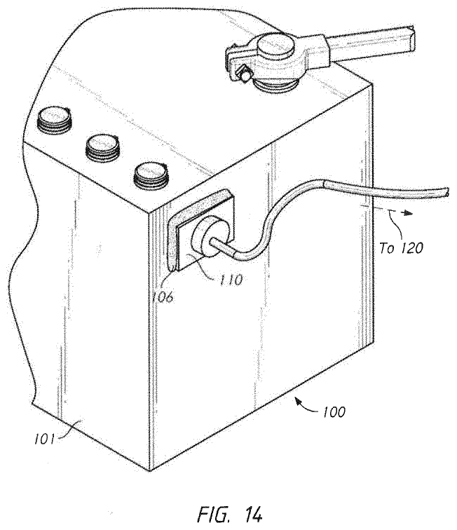

FIG. 14 depicts a three dimensional view of an ultrasound probe applying ultrasound energy into a battery cell through the battery casing using an ultrasound conductive gel 106. A flat ultrasound transmitter 110 is temporarily held against the battery case 101 wall. In this embodiment, to improve ultrasound energy transmission, a gel may be applied to the surface of ultrasound transmitter 110 to eliminate any air gap due to surface irregularities. After sonication at a position, the ultrasound transmitter 110 may be moved to another location as desired. This configuration may allow access to treat portions of a cell that are not readily accessible with an immersion type ultrasound transmitter 110.

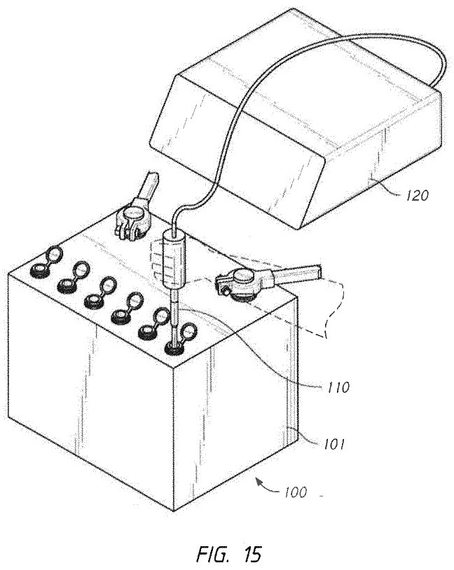

FIG. 15 depicts a three dimensional view of an ultrasound probe inserted into a battery cell.

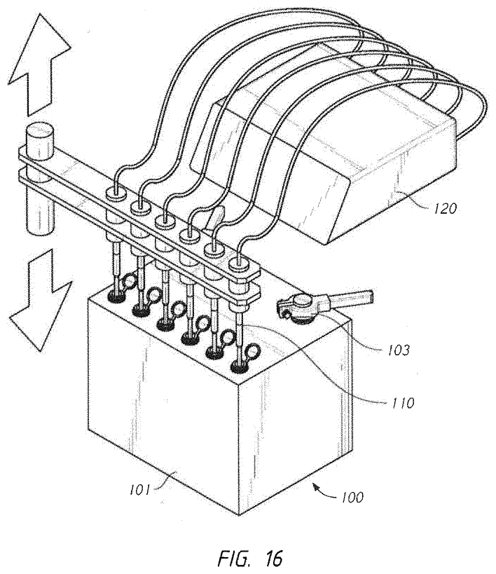

FIG. 16 depicts three dimensional of ultrasound probes inserted into a battery using an automated assembly line. As an automated version or the ultrasound treatment for battery repair or reconditioning, this embodiment would be useful for preconditioning batteries with ultrasound energy as they are being manufactured in a production facility. With the controlled application of ultrasound energy, it may be possible to extend the life of a battery as it is being manufacture. For example, cavitation may help increase plate porosity and/or remove initial corrosion deposits. This device would also be appropriate at a facility responsible for salvaging or reconditioning batteries on a large volume basis so that an assembly line approach would be desired.

### LIST OF ELEMENTS

Battery 100
Battery case 101
Cathode terminal 102
Anode terminal 103
Electrolyte 104
Plates 105
Ultrasound conductive gel 106
Ultrasound transducer 110
Ultrasound generator 120
Soluble (active) precipitate 130
Insoluble (inert) precipitate 131

1. A method for charging a battery comprising the steps of:
a. placing an ultrasound transducer in communication with a portion of a battery, and
b. applying the ultrasound energy at a frequency for a period of time.

2. The method of claim 1 wherein the ultrasound transducer is inserted into the electrolyte.

3. The method of claim 1 wherein the ultrasound transducer is placed against the battery case.

4. The method of claim 1 wherein the period of time is approximately equal to the charging time of the battery.

5. The method of claim 1 wherein the ultrasound transducer also includes an ultrasonic conductive gel.

6. The method of claim 1 wherein the ultrasound transducer is conditioning the battery within an implanted medical device.

7. A method of claim 1 for conditioning a battery also comprising the step of removing lead sulfate from a battery plate.

8. The method of claim 1 wherein the ultrasound transducer shape of distal end of tip is selected from the group of; flat, rounded, conical, rectangular, spherical, cymbal, oval, or elliptical.

9. The method of claim 1 for conditioning a battery wherein the ultrasound transducer generates ultrasound energy at a frequency between 20 kHz and 50 kHz; the ultrasound energy being directed toward the internal components of the battery for a minimum period between 1 second and 60 seconds.

10. The method of claim 1 wherein the ultrasound transducer has an amplitude from 1 micron to 1,000 microns.

11. A method of claim 1 for conditioning a battery also comprising the step of disrupting a plurality of density gradients within the battery.

12. The method of claim 11 wherein electric charge holding capacity of the battery is increased.

13. The method of claim 11 having an additional step of monitoring the charged state of the battery during conditioning.

14. A battery comprising:
a) a battery case having a cathode and an anode;
b) an electrolyte contained within the battery case;
c) the electrolyte including a plurality of lithium ions;
d) the lithium ions reversibly forming lithium crystals;
e) an ultrasound generator controlling an ultrasound transducer; and
f) the ultrasound transducer sonicating at least a portion of the battery.

15. The battery of claim 14, wherein the ultrasound transducer is removed when not sonicating the battery.

16. The battery of claim 14, wherein the ultrasound transducer is permanently mounted to the battery case.

17. The battery of claim 14, wherein ultrasound transducer is immersable.

18. The battery of claim 14, wherein ultrasound transducer tips creates a plurality of cavitation bubbles in electrolyte solution in sonication process.

19. The battery of claim 14, wherein ultrasound generator operates on a duty cycle that may be constant, pulsed or modulated.

20. The battery of claim 14, wherein the electrolyte, passing through the transducer receives ultrasound energy as it passes through the transducer and fills the battery case.
